(19) United States
(12) Patent Application Publication
(10) Pub. No.: US 2016/0056418 A1
(43) Pub. Date: Feb. 25, 2016

(54) LI-ION MONOBLOCK BATTERY FOR STOP/START APPLICATIONS

(71) Applicant: Ford Global Technologies, LLC, Dearborn, MI (US)

(72) Inventors: Xiao Guang YANG, Northville, MI (US); Renata Michaela ARSENAULT, Plymouth, MI (US)

(21) Appl. No.: 14/464,776

(22) Filed: Aug. 21, 2014

(51) Int. Cl. H01M 2/02; H01M 10/0567; H01M 4/58; H01M 10/0525; H01M 2/12; H01M 2/36

(52) U.S. Cl. CPC H01M 2/024; H01M 2/12; H01M 2/362; H01M 4/5825; H01M 10/0525; H01M 10/0567; H01M 2220/20; H01M 2300/0025

(57) ABSTRACT

A Li-ion battery module for stop/start vehicle applications is disclosed. The battery module comprises a plurality of unsealed battery cells that are interconnected in series and positioned in a common housing containing an electrolyte that is shared by the battery cells. The electrolyte may have a redox shuttle agent therein.

### TECHNICAL FIELD

The present disclosure relates to a lithium ion battery arrangement, and more particularly, to a lithium ion mono-block design that utilizes a common electrolyte for cost-effective reliable battery performance.

### BACKGROUND

When integrated in an otherwise convention combustion-engine power train, engine stop-start technology can deliver a considerable fuel savings for a marginal increase in cost. Traditionally, absorbent glass mat (AGM) lead acid batteries were used for this function, as the technology has been proven, and is relatively inexpensive to manufacture. However, such batteries exhibit low energy density and are slow to recharge, as well as being environmentally unfriendly.

Lithium-ion (Li-ion) battery modules have been used in the consumer industry as a rechargeable power supply for consumer products such as laptop computers. As these battery arrangements are lighter, and made from materials that are less toxic than other types of batteries, including lead acid batteries, Li-ion batteries may be useful for enhancing vehicle performance and fuel economy.

### SUMMARY

A first configuration of a Li-ion battery module for stop/start vehicle applications comprises a plurality of unsealed battery cells that are interconnected in series and positioned in a common housing. The housing contains an electrolyte that is shared by the battery cells. In some instances, the shared electrolyte can include a redox shuttle agent therein.

Another configuration of a Li-ion battery module for stop/start vehicle applications comprises first, second, third and fourth unsealed battery cells. Each battery cell includes a positive tab and a negative tab. The positive tab of the first cell is connected to the negative tab of the second cell by a weld joint. The positive tab of the second cell is connected to the negative tab of the third cell by a weld joint. The positive tab of the third cell is connected to the negative tab of the fourth cell by a weld joint. In this manner, the battery cells are interconnected in series. The first, second, third and fourth unsealed battery cells are positioned in a common housing containing electrolyte having a redox shuttle agent therein.

### BRIEF DESCRIPTION OF THE DRAWINGS

FIG. 1 is a schematic drawing of a first exemplary arrangement of a Li-ion mono-block battery;

FIG. 2 is a schematic drawing of a second exemplary arrangement of a Li-ion mono-block battery; and

FIG. 3 is a top plan view of a schematic drawing of a third exemplary arrangement of a Li-ion mono-block battery.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

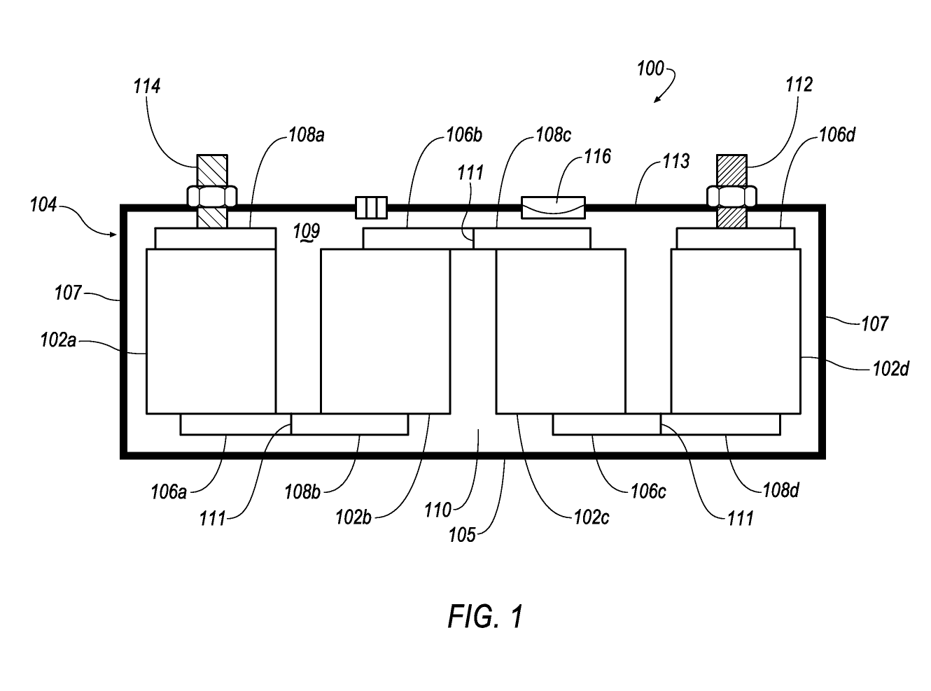

A first exemplary arrangement of a Li-ion mono-block battery module 100 for use in connection with the stop-start function in a vehicle is illustrated in FIG. 1. Battery 100 may be used in a rechargeable battery of a hybrid vehicle or an electric vehicle, for example, serving as a power source that drives an electric motor of the vehicle. Battery 100 includes a plurality of individual LiFePO₄ cells 102a, 102b, 102c, 102d that are positioned a common sealed housing 104 and electrically interconnected. While four cells are depicted in FIGS. 1-3, it is understood that the disclosure is not limited to a particular number of cells. In some applications, more or less cells may be used.

In the arrangement FIG. 1, the cells 102a, 102b, 102c, and 102d are arranged adjacent one another. In one example, the Li-ion cells may be LiFePO₄ cells, although it is understood that the disclosure is not limited to Li-ion cells having this specific chemistry. LiFePO₄ cells do provide: (i) the appropriate operational voltage (3-3.8 V/cell times 4 cells) that is capable of meeting the typical 12 V requirement for most vehicle electrical systems, as well as (ii) an upper voltage range (lower than other Li-ion chemistries) that is suited for application of overcharge-mitigating redox shuttle additives (to be discussed below). However, battery modules having other Li-ion cell chemistries are specifically contemplated in this disclosure.

Each cell 102a, 102b, 102c, and 102d includes a positive tab 106 and a negative tab 108. The commonly housed cells 102a, 102b, 102c, and 102d are electrically connected in series to achieve a predetermined module voltage. In one particular instance, for LiFePO₄ cells, four cells are electrically connected together to achieve a module voltage of at least 12 V. In one arrangement, the positive tab 106a of cell 102a, is joined to the negative tab 108b of the adjacent cell 102b via a weld joint 111. However, other tab orientations are also contemplated. Unlike prior art battery modules, the individual cells 102a, 102b, 102c, and 102d are unsealed when positioned within the housing 104. The cells 102a, 102b, 102c, and 102d may be constructed with any suitable geometry, such as, for example, prismatic or cylindrical. Moreover, the electrode format may be constructed as either a stacked or wound format.

The housing 104 may be metallic, composite or plastic and is configured to hold a common electrolyte 110 that is shared by the unsealed cells 102a, 102b, 102c, and 102d. The housing 104 may be configured with any suitable shape to hold the cells 102a, 102b, 102c and 102d. In one exemplary arrangement, the housing 104 includes a bottom wall 105, opposing first side walls 107, opposing second side walls 109 and a top wall 113. The walls 105, 107, 109 and 113 are configured to fit together to provide a sealed housing 104. In one exemplary configuration, all of the cells 102a, 102b, 102c, and 102d are arranged in the housing 104 such that each has a generally central axis extending therethrough that is generally perpendicular to a plane defined by the bottom wall 105, but the individual cells are positioned adjacent one another in a horizontal direction.

In one exemplary arrangement, optional retaining elements may be provided to position the individual cells in the housing 104. More specifically, a retaining element may have one end fixedly secured to an inside surface of the wall member, with a retaining member engaging the cell. While the retaining member may have any suitable configuration, in one example, the retaining element may have a circular configuration that is disposed around the outer periphery of each cell.

In one exemplary arrangement, if the individual Li-ion cells are of sufficient quality fabrication, i.e., manufactured to tight tolerances, the shared electrolyte 110 is sufficient to prevent thermal runaway and balance the charge of the individual cells. However, it is also contemplated that for Li-ion cells where the tolerances are unknown or are slightly relaxed, the electrolyte 110 that is stored in the housing 104 with the individual cells may include a redox shuttle additive, which will be discussed in further detail below.

Hardware features, such as the terminals, vent and electrolyte fill port that are normally integrated into each sealed cell in the prior art, are no longer needed for each individual cell. Instead, the housing 104, which is sealed, includes a positive terminal 112 and a negative terminal 114. A vent 116 is integrated into the housing 104. The vent serves to release pressure from the housing 104 if the pressure within the housing 104 exceeds a predetermined threshold. The housing 104 also includes a fill port 118 for introducing the electrolyte 110 into the housing 104. This configuration allows for parts reduction over traditional battery modules, as well as an associated cost savings.

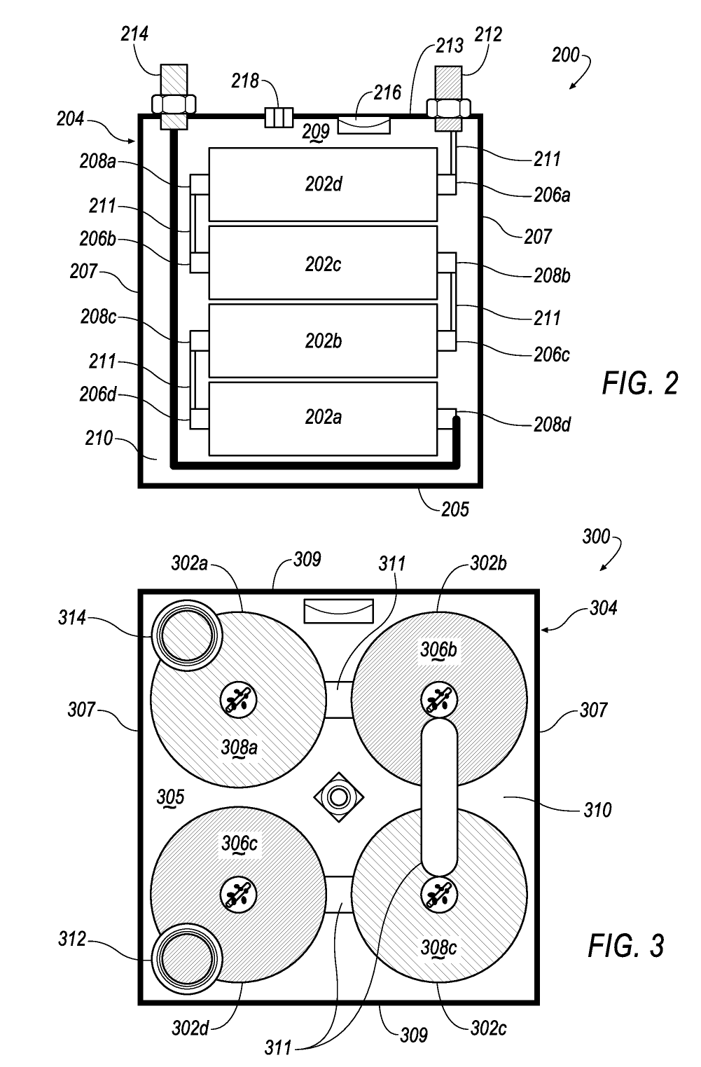

A second exemplary arrangement of a Li-ion mono-block battery module 200 is illustrated in FIG. 2. Battery module 200 includes a plurality of individual LiFePO₄ cells 202a, 202b, 202c, and 202d that are positioned a common sealed housing 204 and electrically interconnected.

Each cell 202a, 202b, 202c, and 202d includes a positive tab 206 and a negative tab 208. The commonly housed cells 202a, 202b, 202c, and 202d are electrically connected in series to achieve a predetermined module voltage. For example, in one arrangement, the positive tab 206a of cell 202a, is joined to the negative tab 208b of the adjacent cell 202b via a weld joint 211. However, other tab orientations are also contemplated. Unlike prior art battery modules, the individual cells 202a, 202b, 202c, and 202d are unsealed when positioned within the housing 204. The cells 202a, 202b, 202c, and 202d may be constructed with any suitable geometry, such as, for example, prismatic or cylindrical.

The housing 204 may be metallic, composite or plastic and is configured to hold a common electrolyte 210 that is shared by the unsealed cells 202a, 202b, 202c, and 202d. The electrolyte 210 may or may not include a redox shuttle additive, which will be discussed in further detail below. The housing 204 may be configured with any suitable shape to hold the cells 202a, 202b, 202c and 202d. In one exemplary arrangement, the housing 104 includes a bottom wall 205, opposing first side walls 207, opposing second side walls 209 and a top wall 213. The walls 205, 207, 209 and 213 are configured to fit together to provide a sealed housing 204. In the arrangement FIG. 2, the cells 202a, 202b, 202c, and 202d each have a central axis, with the axes of the cells being coplanar in a vertical direction, such that the cells are arranged adjacent one another in a vertical direction.

Hardware features, such as the terminals, vent and electrolyte fill port that are normally integrated into each sealed cell in the prior art, are no longer needed for each individual cell. Instead, the housing 204, which is sealed, includes a positive terminal 212 and a negative terminal 214, each of which is electrically connected to the individual cells 202a, 202b, 202c, and 202d. A vent 216 is integrated into one of the walls of housing 204. The housing 204 also includes a fill port 218 for introducing the shared electrolyte 210 into the housing 204. This configuration also allows for parts reduction over traditional battery modules, as well as an associated cost savings.

A third exemplary arrangement of a Li-ion mono-block battery module 300 is illustrated in FIG. 3. Battery module 300 includes a plurality of individual LiFePO₄ cells 302a, 302b, 302c, and 302d that are positioned a common sealed housing 304 and electrically interconnected. In the arrangement FIG. 3, the cells 302a, 302b, 302c, and 302d are arranged in two rows, with two cells in each row.

Each cell 302a, 302b, 302c, and 302d includes a positive tab 306 and a negative tab 308, only some of which are visible in FIG. 3. The commonly housed cells 302a, 302b, 302c, and 302d are electrically connected in series to achieve a predetermined module voltage. For example, in one arrangement, the positive tab 306b of cell 302b, is joined to the negative tab 308c of the adjacent cell 302c via a weld joint 311. However, other tab orientations are also contemplated. Unlike prior art battery modules, the individual cells 302a, 302b, 302c, and 302d are unsealed when positioned within the housing 304. The cells 302a, 302b, 302c, and 302d may be constructed with any suitable geometry, such as, for example, prismatic or cylindrical.

The housing 304 may be metallic, composite or plastic and is configured to hold a common electrolyte 310 that is shared by the unsealed cells 302a, 302b, 302c, and 302d. The electrolyte 310 includes a redox shuttle additive, which will be discussed in further detail below. The housing 304 may be configured with any suitable shape to hold the cells 302a, 302b, 302c and 302d. In one exemplary arrangement, the housing 304 includes a bottom wall 305, opposing first side walls 307, opposing second side walls 309 and a top wall, which has been removed for illustrative purposes. The walls 305, 307, and 309 are configured to fit together to provide a sealed housing 104.

Hardware features, such as the terminals, vent and electrolyte fill port that are normally integrated into each sealed cell in the prior art, are no longer needed for each individual cell. Instead, the housing 304, which is sealed, includes a positive terminal 312 and a negative terminal 314, each of which is electrically connected to the individual cells 302a, 302b, 302c, and 302d. A vent 316 is integrated into one of the walls of housing 304 (such as the top wall). The housing 304 also includes a fill port 318 for introducing the shared electrolyte 310 into the housing 304. This configuration also allows for parts reduction over traditional battery modules, as well as an associated cost savings.

All of the battery modules 100, 200, 300 may include a redox shuttle additive in the common electrolyte for the individual battery cells. A redox shuttle additive is an electrolyte additive that can be used as intrinsic overcharge protection mechanism to enhance the safety characteristics of lithium-ion batteries. More specifically, for the exemplary LiFePO₄ Li-ion cells with special redox additives can be overcharged for 1 hour at 1 C to 4 V (which is greater than its normal (100% state of charge) maximum voltage of 3.6 V) up to a state of charge of 200% without abnormal performance loss and safety issue. Even after being overcharged hundreds of times, the cell continues to behave normally. In contrast, Li-ion cells that are not manufactured with tight tolerances and do not include redox shuttle additives can experience irreversible damage after a single overcharge event. Therefore, both cell imbalance and overcharge concerns of the disclosed modules 100, 200, 300 may be addressed by the inclusion of the shuttle reaction function of the redox shuttle additives.

A redox shuttle additive is able to convert a large amount of overcharge current into heat with negligible damage to the cell. In the absence of the “reaction-diverting” redox shuttle additives, the cell would be allowed to go into overcharge (which could lead to thermal runaway) without the presence of a costly voltage monitoring and control system. Indeed, for safety reasons, namely prevention of overcharge, thermal runaway, among others, certain properties of traditional Li-ion cells must be carefully monitored (i.e., voltage and temperature) and regulated. However, due to the function of the redox shuttle additives, the battery modules 100, 200, and 300 do not require the complex electrical system for monitoring and regulating individual cell voltages. For those arrangements where tight tolerances of the unsealed cells are maintained, the common electrolyte may also provide needed overcharge protection. In either arrangement, the information on the state of charge of individual cells is no longer needed, so that the battery control algorithms and related hardware can be further simplified. Moreover, the monoblock battery module 100, 200, 300 designs also have the potential to improve heat exchange and heat distribution capability, thereby representing an opportunity for simplification of a thermal management system. The reductions in system components and complexity translate into a cost savings, but without compromising performance.

In a stop-start electrical system in an operating vehicle, the battery module is kept near a “top of charge” most of the time. As such, the proposed battery modules 100, 200, 300 described herein are very well suited for the stop-start application, where most of the operation takes place in the upper voltage range, and where the redox shuttle reactions take place.

A number of redox shuttle additives have been found useful for the exemplary LiFePO₄ battery modules 100, 200, and 300. Examples include 1,4-bis(2-methozyethoxy)-2-,5-di-tert-butylbenzene, 2,5-ditert-butyl-1,4,dimethoxy benzene, 4-tert-butyl-1,2-dimethoxybenzene, Monomethoxy benzene class compounds, hexaethyle benzene, bipyridyl or biphenyl carbonates, difluoroanisoles, S or N containing hertocyclic aromatic compounds (for example, 2,7-diacetyl thianthrene), phenothiazine based molecules (for example, 10-methylphenothiazine, 10-ethylphenothianzine). It is understood that the above list is exemplary only and that use of other suitable redox shuttle additives in the shared electrolyte are contemplated by this disclosure. It is further contemplated that other appropriate redox shuttle additive that are capable of completing a charge balancing operation for a particular Li-ion battery module, including other Li-ion cells having different chemical compositions, are within the scope of this disclosure.

The exemplary battery modules 100, 200, 300 of the present disclosure serve to lower battery costs through elimination of hardware for each individual cells. Indeed, terminals, individual sealing packages (such as pouch or can configurations), safety devices such as current-interrupt devices, or individual vents are no longer needed for each cell. Instead, a common vent is employed per module, enabling a simple and convenient design of a venting/exhaust system (for battery abuse conditions leading to thermal runaway). Elimination of these components from the individual cells also reduce manufacturing costs associated with the individual cells.

Exemplary battery modules 100, 200, 300 also serve to increase volumetric and specific energy density and power density by lowering weight/volume and connection resistance between adjacent cells, as now the individual cells are unsealed and in a common electrolyte. Indeed, the use of a common electrolyte in a common housing for multiple cells results in better thermal and performance uniformity amount the individual cells, thereby offering added flexibility in thermal management system design, while eliminating expensive rebalancing electrical circuitry and control software.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A Li-ion battery module for stop/start vehicle applications, comprising:
a plurality of unsealed battery cells interconnected in series and positioned in a common housing containing an electrolyte shared between the unsealed battery cells.

2. The Li-ion battery module of claim 1, further comprising a redox shuttle agent in the electrolyte.

3. The Li-ion battery module of claim 2, wherein the redox shuttle agent is selected from the group consisting of 1,4-bis(2-methozyetozy)-2,5-di-tert-butylbenzene, 2,5-ditert-butyl-1,4,dimethoxy benzene, 4-tert-butyl-1,2-dimethoxybenzene, Monomethoxy benzene class compounds, hexaethyle benzene, bipyridyl or biphenyl carbonates, difluoroanisoles, S or N containing hertocyclic aromatic compounds, and phenothiazine based molecules.

4. The Li-ion battery module of claim 1, wherein each battery cell is a LiFePO₄ cell.

5. The Li-ion battery module of claim 1, wherein each battery cell has a nominal voltage of 3.3-3.7 V.

6. The Li-ion battery module of claim 1, wherein the plurality of battery cells includes first, second, third and fourth battery cells arranged adjacent to one another in a horizontal direction.

7. The Li-ion battery module of claim 6, wherein each battery cell has a positive tab and a negative tab, and wherein the positive tab of the first cell is connected to the negative tab of the second cell by a weld joint, and wherein the positive tab of the second cell is connected to the negative tab of the third cell by a weld joint, and wherein the positive tab of the third cell is connected to the negative tab of the fourth cell by a weld joint.

8. The Li-ion battery module of claim 1, wherein the plurality of battery cells includes four battery cells arranged adjacent to one another in a vertical direction.

9. The Li-ion battery module of claim 8, wherein each battery cell has a positive tab and a negative tab, and wherein the positive tab of the first cell is connected to the negative tab of the second cell by a weld joint, and wherein the positive tab of the second cell is connected to the negative tab of the third cell by a weld joint, and wherein the positive tab of the third cell is connected to the negative tab of the fourth cell by a weld joint.

10. The Li-ion battery module of claim 1, wherein the plurality of battery cells includes four battery cells arranged in two rows.

11. The Li-ion battery module of claim 10, wherein each battery cell has a positive tab and a negative tab, and wherein the positive tab of the first cell is connected to the negative tab of the second cell by a weld joint, and wherein the positive tab of the second cell is connected to the negative tab of the third cell by a weld joint, and wherein the positive tab of the third cell is connected to the negative tab of the fourth cell by a weld joint.

12. The Li-ion battery module of claim 1, wherein the housing further comprises a vent through a wall of the housing.

13. The Li-ion battery module of claim 1, wherein the housing further comprises a fill port for introducing electrolyte into the housing.

14. The Li-ion battery module of claim 1, wherein the housing includes a positive terminal and a negative terminal, wherein the positive terminal is electrically connected to a positive tab of one of the cells and wherein the negative terminal is electrically connected to a negative tab of another cell.

15. A Li-ion battery module for stop/start vehicle applications, comprising:
a plurality of unsealed LiFePO₄ battery cells interconnected in series and positioned in a common housing containing an electrolyte having a redox shuttle agent therein.

16. A Li-ion battery module for stop/start vehicle applications, comprising:
first, second, third and fourth unsealed battery cells, each having a positive tab and a negative tab,
wherein the positive tab of the first cell is connected to the negative tab of the second cell by a weld joint, and wherein the positive tab of the second cell is connected to the negative tab of the third cell by a weld joint, and wherein the positive tab of the third cell is connected to the negative tab of the fourth cell by a weld joint, so as to interconnect the battery cells in series; and
wherein the first, second, third and fourth unsealed battery cells are positioned in a common housing containing electrolyte having a redox shuttle agent therein.

17. The Li-ion battery module of claim 16, wherein the housing further comprises a vent through a wall of the housing.

18. The Li-ion battery module of claim 16, wherein the housing further comprises a fill port for introducing electrolyte into the housing.

19. The Li-ion battery module of claim 16, wherein the housing includes a positive terminal and a negative terminal, wherein the positive terminal is electrically connected to a positive tab of one of the cells and wherein the negative terminal is electrically connected to a negative tab of another cell.

20. The Li-ion battery module of claim 16, wherein the redox shuttle agent is selected from the group consisting of 1,4-bis(2-methozyetozy)-2,5-di-tert-butylbenzene, 2,5-ditert-butyl-1,4,dimethoxy benzene, 4-tert-butyl-1,2-dimethoxybenzene, Monomethoxy benzene class compounds, hexaethyle benzene, bipyridyl or biphenyl carbonates, difluoroanisoles, S or N containing hertocyclic aromatic compounds, and phenothiazine based molecules.
